(19) United States
(12) Patent Application Publication
(10) Pub. No.: US 2023/0217921 A1
(43) Pub. Date: Jul. 13, 2023

(54) DECORATIVE PANEL HAVING ANTIMICROBIAL PROPERTIES

(71) Applicant: FLOORING INDUSTRIES LIMITED, SARL, Bertrange (LU)

(72) Inventors: Benjamin CLEMENT, Waregem (BE); Sam LEDEGEN, Gent (BE)

(21) Appl. No.: 18/009,137

(22) PCT Filed: May 19, 2021
(86) PCT No.: PCT/IB2021/054314

§ 371 Date: Dec. 8, 2022

(30) Foreign Application Priority Data
Jun. 12, 2020 (BE) 2020/5426

(51) Int. Cl. A01N 25/34; E04F 13/18; E04F 13/10; E04F 15/04; E04F 15/10; A01N 59/26; A01P 1/00; B32B 29/00; B32B 3/30

(52) U.S. Cl. CPC A01N 25/34; A01N 59/26; A01P 1/00; B32B 3/30; B32B 29/005; E04F 13/10; E04F 13/18; E04F 15/045; E04F 15/105; B32B 3/06; B32B 2255/12; B32B 2260/028; B32B 2260/046

(57) ABSTRACT

A decorative panel includes a substrate, a decor layer and a cover layer. The cover layer has a lacquer or is composed of a lacquer. The lacquer includes antimicrobial additives; and has an acrylate matrix and/or a methacrylate matrix.

The invention relates to decorative panels having antimicrobial properties. The panels of the invention can be used as a floor panel, a wall panel, or a ceiling panel. The invention also relates to methods for producing such decorative panels.

WO2009/062516A2 relates to a panel having an upper surface that has a base and at least one cover layer above this base. At least one of these cover layers comprises embedded nanoparticles so that the upper surface shows hydrophilic properties. These hydrophilic properties make it easy to clean the panel. The use of titanium dioxide nanoparticles is described as an example. It is also disclosed that these titanium dioxide-containing nanoparticles can show photocatalytic activity. It is disclosed that the photocatalytic activity of the nanoparticles provides a better climate in the room in which the panels are installed. It is clear that for this photocatalytic activity, suitable light must be available in order to induce the photocatalytic activity of the nanoparticles.

An object of the invention is to provide decorative panels with antimicrobial and preferably also antiviral properties. A specific object of embodiments of the invention is to provide decorative panels that have antimicrobial properties, have high wear resistance, are easy to clean, and provide an imitation of wood, natural stone, or a ceramic panel. An object is also to have a long-lasting antimicrobial action, preferably during the entire lifetime of the panel. A specific object of embodiments of the invention is to provide panels that have favorable sound damping properties in use as a floor panel.

The first aspect of the invention is a decorative panel. The decorative panel comprises a substrate, a decor layer, and a cover layer. The cover layer comprises a lacquer or is composed of a lacquer. The lacquer comprises antimicrobial additives. The lacquer comprises an acrylate matrix and/or a methacrylate matrix. This lacquer is therefore on the surface of the decorative panel.

Decorative panels in accordance with the first aspect of the invention provide antimicrobial activity that is long-lasting and that does not depend on the conditions of use and environmental conditions.

Preferably, the matrix of the lacquer is at least partially cured by means of UV irradiation and/or by means of electron beam.

Preferably, photoinitiators are built into the lacquer. Such embodiments make it possible to cure the lacquer in an efficient and effective manner in production of the panel.

Preferably, the antimicrobial additives in the lacquer are selected from one or more of particles comprising silver components (such as particles comprising silver phosphate, more preferably silver phosphate glass particles), quaternary ammonium salts, quaternary ammonium groups built into the matrix of the lacquer, particles or additives that comprise quaternary ammonium groups, metallic silver particles, silver salts, silver complexes, silver chelates, copper salts, copper and alloys thereof (such as brass, bronze, copper-nickel, copper-nickel-zinc), zinc oxide, essential oils, oleoresins (such as linalool or thymol), polybiguanides, chitosan, isothiazolinone, antibiotics, or trichloromethylsulfenyl-containing fungicides, silver adsorbed to silicon oxide, silver chloride adsorbed to titanium dioxide, silver nitrate, silver sodium hydrogen zirconium phosphate, silver zinc zeolite, silver copper zeolite, silver phosphate glass, and silver borosilicate glass.

The use of silver components that comprise silver in ionic form provides the specific advantage that such antimicrobial additives do not leach out, and thus maintain their antimicrobial action over time, even in frequent wet cleaning of the decorative panels. The use of silver phosphate glass particles is particularly advantageous, because the silver ions that have the antimicrobial action are efficiently embedded in the silver phosphate glass, and the silver phosphate glass is then in turn efficiently embedded in the lacquer. In this manner, silver ions are released in a controlled manner that provide the antimicrobial action, so that the antimicrobial action is maintained in a very long-lasting manner. As silver phosphate glass particles are very efficient in such lacquer layers, only a small amount thereof is necessary.

Preferably, the amount of antimicrobial additives in the lacquer is between 0.1 and 4% by weight, more preferably between 0.2 and 2% by weight.

In a preferred embodiment, the lacquer is located on an adhesive layer, and more preferably, the adhesive layer comprises an acrylate and/or a methacrylate. Such an adhesive layer provides better adhesion of the lacquer to the decorative panel.

Preferably, the optional adhesive layer is thinner than 20 µm, more preferably thinner than 10 µm; and preferably thicker than 5 µm.

A thin adhesive layer is advantageous in that the transparency is minimally affected, and the texture in the panel is maintained, and is not, as it were, “lacquered in.”

Preferably, the optional adhesive layer comprises antimicrobial additives; and this preferably when the lacquer is thinner than 20 µm, more preferably when the lacquer is thinner than 10 µm. Preferably, the lacquer is thicker than 5 µm.

Such embodiments are advantageous in that the decorative panel maintains its antimicrobial properties if the lacquer does not cover the entire surface of the panel. This can for example be the case if the surface of the panel comprises a texture, or if the application of the lacquer does not have a completely correct configuration, or if a thin lacquer is applied. A thin lacquer is advantageous in that the transparency is minimally affected, and the texture in the panel is maintained, and is not, as it were, “lacquered in.”

Preferably, the antimicrobial additives in the optional adhesive layer are selected from one or more of particles comprising silver components (such as particles comprising silver phosphate, more preferably silver phosphate glass particles), quaternary ammonium salts, quaternary ammonium groups built into the matrix of the lacquer, particles or additives that comprise quaternary ammonium groups, metallic silver particles, silver salts, silver complexes, silver chelates, copper salts, copper and alloys thereof (such as brass, bronze, copper-nickel, copper-nickel-zinc), zinc oxide, essential oils, oleoresins (such as linalool or thymol), polybiguanides, chitosan, isothiazolinone, antibiotics, or trichloromethylsulfenyl-containing fungicides, silver adsorbed to silicon oxide, silver chloride adsorbed to titanium dioxide, silver nitrate, silver sodium hydrogen zirconium phosphate, silver zinc zeolite, silver copper zeolite, silver phosphate glass, and silver borosilicate glass.

More preferably, the antimicrobial additives in the optional adhesive layer are the same as the antimicrobial additives in the lacquer.

Preferably, the amount of antimicrobial additives in the adhesive layer is between 0.1 and 4% by weight, more preferably between 0.2 and 2% by weight.

Preferably, the decor layer comprises a printed decor or the decor layer is composed of a printed decor. Optionally, the cover layer comprises a transparent layer, more preferably on the printed decor. The transparent layer can for example comprise a transparent film or be composed thereof. An example of such a transparent film that can be used in the invention is a transparent polyvinyl chloride film or a polyvinyl chloride film.

In embodiments wherein the cover layer comprises a transparent layer, the transparent layer preferably comprises a biocide. More preferably, the transparent layer comprises between 0.1 and 2% by weight of the biocide. Such embodiments are advantageous in that even on deterioration of the lacquer, or even the optional adhesive layer, or on depletion of the antimicrobial additives in the lacquer, the panel still has antimicrobial properties.

Optionally, the cover layer comprises a microstructure and/or a relief. Such a microstructure and/or relief can for example be formed in the transparent layer if said layer is present.

Preferably, the surface of the cover layer has a gloss value lower than 20; preferably lower than 10, and more preferably lower than 5. The gloss value is measured and expressed in accordance with the regulations in ISO 2813:2014 entitled “Paints and varnishes — Determination of gloss value at 20 degrees, 60 degrees and 85 degrees.”

In preferred embodiments, the lacquer comprises less than 5% by weight of a matting agent, more preferably, the lacquer comprises less than 2% by weight of a matting agent; and more preferably, the lacquer comprises less than 1% by weight of a matting agent.

Such embodiments with low amounts of a matting agent in the lacquer are advantageous in that better durability of the panel is achieved. Higher amounts of matting agents weaken the acrylate matrix, which sharply reduces the durability of the cover layer.

The above-mentioned low amount of matting agents – and preferably the absence thereof –provides a synergistic advantage by means of which the antimicrobial action of the antimicrobial additive is improved and/or by means of which smaller amounts of antimicrobial additives are needed. Matting agents and open pores in the acrylate matrix that arise due to a high amount of matting agents can contain dirt and impurities; such dirt and/or impurities can stimulate microbial growth.

Matting agents that can be used in these limited amounts in the lacquer are preferably pyrogenic silica (known in English as “fumed silica”), precipitated silica (known in English as “precipitated silica”), silica treated with wax (known in English as “wax treated silica”), polycondensed plastics, micronized organic polymer, or PMMA (polymethyl methacrylate) beads. The use of a limited amount of a matting agent can be useful in order to regulate the viscosity of the lacquer.

The lacquer can also be completely free of matting agents, and this is preferred.

If the lacquer comprises – more preferably limited – amounts of matting agents, no titanium dioxide is preferably used, because this imparts to the lacquer an undesirable white effect. For this reason, the lacquer preferably comprises no titanium dioxide.

Panels that have a gloss value lower than 10; and more preferably lower than 5; and wherein the lacquer comprises less than 5% by weight of matting agents (and more preferably less than 2% by weight of a matting agent; and more preferably less than 1% by weight of a matting agent) have a specific advantage. Such panels provide a favorable imitation of wood, natural stone, or a ceramic panel. The reason is that the low gloss value of the lacquer prevents a synthetic appearance. The low amount of matting agent – or even the absence of a matting agent – ensures that the strength of the acrylate matrix of the lacquer is maintained. This provides a durable lacquer and a durable cover layer. The strong, sealed acrylate matrix also provides easy and favorable cleanability of the surface of the decorative panel. The above-mentioned low amount of matting agents – and preferably the absence thereof – provides a synergistic advantage by means of which the antimicrobial action of the antimicrobial additive is improved and/or by means of which smaller amounts of antimicrobial additives are needed. Open pores in the acrylate matrix that arise due to a high amount of matting agents, and the matting agents themselves, can contain dirt and impurities; such dirt and/or impurities can stimulate microbial growth.

Such panels with the above-mentioned low gloss value and low amount of a matting agent in the lacquer (or even absence of a matting agent in the lacquer) can be achieved by applying the flowable lacquer-which may comprise oligomers, monomers, one or more photoinitiators, the antimicrobial additives, and optionally other additives as well-and then briefly curing the surface of the lacquer by means of an excimer light source. This provides crimping stresses at the surface of the lacquer that cause the formation of a microtexture (and the low gloss value). The excimer light source is immediately followed by a UV curing step, wherein the lacquer is cured in further depth.

Preferably, the lacquer comprises particles that increase the wear resistance of the decorative panel, preferably selected from one or more of nanosilicate, aluminum oxide (such as in the form of corundum) and diamond, more preferably synthetic diamond.

More preferably, the lacquer comprises between 0.1 and 10% by weight of additives that increase the wear resistance of the decorative panel.

Preferably, the substrate is composed of multiple polyvinyl chloride layers or the substrate comprises multiple polyvinyl chloride layers. Optionally, one or more of these layers comprises a filler and/or other additives, and optionally, one or more of the polyvinyl chloride layers is/are foamed.

Embodiments wherein the substrate comprises multiple polyvinyl chloride layers are advantageous in that panels with favorable stability and favorable sound damping properties can be obtained, preferably by varying the properties of the different layers. This is particularly important in use of the panels as a floor panel.

Preferably, the thickness of the substrate is between 2 mm and 12 mm, and more preferably, the thickness of the substrate is less than 8 mm.

Preferably, the decor layer comprises a printed polyvinyl chloride film, and more preferably, the printed polyvinyl chloride film is between 40 and 150 µm thick.

Preferably, a transparent polyvinyl chloride film is applied to the printed polyvinyl chloride film. More preferably, the transparent polyvinyl chloride film has a thickness of between 50 and 1000 µm.

Preferably, the transparent polyvinyl chloride film is provided with a relief. Such embodiments provide a realistic imitation of natural material, for example a wood imitation.

Such a relief can for example be applied by embossing a relief prior to application of the optional adhesive layer and the lacquer.

Preferably, the transparent polyvinyl chloride film comprises a biocide. More preferably, the transparent polyvinyl chloride film comprises between 0.1 and 2% by weight of the biocide.

Such embodiments are advantageous in that even on deterioration of the lacquer, or even the optional adhesive layer, or on depletion of the antimicrobial additives in the lacquer, the panel still has antimicrobial properties.

Preferably, the substrate comprises a first layer and a second layer, wherein the second layer is located closer to the cover layer. The second layer is composed of more flexible material than the first layer. The second more flexible layer of the substrate provides a sound-damping effect of the panel, particularly in use of the panel as a floor panel. The harder first layer provides better dimensional stability.

Preferably, the first layer is composed of or the first layer comprises an MDF (medium density fiberboard) panel or an HDF (high density fiberboard) panel.

Preferably, the second layer is or comprises a thermoplastic polymer layer or an elastomeric polymer layer. More preferably, this thermoplastic polymer layer or this elastomeric polymer layer comprises fillers, more preferably wood particles, wood fibers or mineral fillers. Such embodiments provide favorable sound damping of the decorative panel.

Preferably, the thermoplastic or elastomeric polymer of the second layer is selected from the series of polyvinyl butyral (PVB), polyvinyl butyrate, polyvinyl chloride (PVC), polyvinyl dichloride (PVdC), polypropylene (PP), polyethylene (PE), polyethylene terephthalate (PET), thermoplastic polyurethane (TPU), and thermoplastic aliphatic polyesters such as polylactic acid (PLA) and thermoplastic olefins (TPO).

In a preferred embodiment, wherein the first layer and the second layer are both polyvinyl chloride layers, preferably, the first layer is foamed and/or the first layer comprises less than 20 phr of a plasticizer, and preferably between 5 and 15 phr of a plasticizer, and more preferably less than 5 phr of a plasticizer. More preferably, the second layer comprises more than 15 phr of a plasticizer, and more preferably more than 20 phr of a plasticizer.

Preferably, the first layer and/or the second layer comprise(s) fillers, more preferably, the fillers are selected from wood particles, wood fibers or mineral fillers. More preferably, the first layer and/or the second layer comprise(s) at least 40% by weight of fillers, and more preferably at least 50% by weight of fillers, and more preferably at least 65% by weight of fillers.

In a preferred embodiment of the invention, the substrate is wood-based, or the substrate comprises one or more wood-based layers. More preferably, the substrate comprises multiple-layer parquet or the substrate is composed thereof.

In a preferred embodiment of the invention, the substrate comprises one or more mineral layers or the substrate is composed of one or more mineral layers. Examples of mineral layers that can be used in the invention are magnesium oxide layers, fiber cement layers, mineral fiber layers (e.g. bonded with a resin), a silicate layer, or plasterboard.

In a preferred embodiment of the invention, the substrate comprises an MDF (medium density fiberboard) panel or an HDF (high density fiberboard) panel, or the substrate is composed of an MDF panel or an HDF panel.

Preferably, the decorative panel is provided at a first pair of opposite edges with coupling components, substantially in the form of male and female coupling components, for coupling two such panels to each other at their first pair of opposite edges, wherein the coupling components are provided with interlocking components, wherein the coupling components and the interlocking components provide interlocking in a coupled state of two such panels in the direction perpendicular to the surface of the coupled panels, as well as in the direction in the plane of the panels and perpendicular to the coupled edges. Such embodiments allow panels to be easily and quickly installed to produce a floating floor covering.

Preferably, the coupling components of the first pair of opposite edges are provided such that two such panels can be coupled at their first pair of opposite edges by means of an angling movement and/or by means of a sliding movement with a snap effect parallel to the surface of the panels.

Preferably, the coupling components are substantially produced from the material of the substrate.

Preferably, the coupling components of the first pair of opposite edges are substantially configured in the form of a tongue and a groove, wherein the tongue and the groove are provided with interlocking components that in a coupled state of two such panels at their first pair of opposite edges provide interlocking in the direction in the plane of the panels and perpendicular to the coupled edges, wherein the groove is delimited by an upper lip and a lower lip, wherein the lower lip protrudes farther in a distal direction than the upper lip, and wherein the part of the lower lip that protrudes farther in a distal manner than the upper lip comprises an interlocking component in the form of an upward facing interlocking component.

Preferably, the coupling components of the first pair of opposite edges are provided such that two such panels can be coupled at their first pair of opposite edges by means of an angling movement and/or by means of a sliding movement with a snap effect parallel to the surface of the panels, and/or by means of a substantially downward movement in the direction perpendicular to the plane of the panels.

Preferably, the decorative panel is provided on a second pair of opposite edges with coupling components, substantially in the form of male and female coupling components, for coupling two such panels to each other at their second pair of opposite edges, wherein the coupling components are provided with interlocking components, wherein the coupling components and the interlocking components provide interlocking in a coupled state of two such panels in the direction perpendicular to the surface of the coupled panels, as well as in the direction in the plane of the panels and perpendicular to the coupled edges, wherein the coupling components of the second pair of opposite edges are provided such that two such panels can be coupled at their second pair of opposite edges by means of an angling movement and/or by means of a sliding movement with a snap effect parallel to the surface of the panels, and/or by means of a substantially downward movement in the direction perpendicular to the plane of the panels.

Preferably, the lacquer comprises one or a combination of one or more of acrylate, methacrylate, urethane acrylate, polyester acrylate, or epoxy acrylate.

Preferably, the decorative panel is rectangular, whether oblong or square.

The decorative panel can for example be a floor panel, a wall panel, or a ceiling panel.

Preferably, the antimicrobial additives have virus-killing activity. This means that the antimicrobial agents ensure that any viruses present on the surface of the decorative panel have a shorter life than they would if the decorative panel did not comprise these antimicrobial additives.

The second aspect of the invention is a method for producing a decorative panel, optionally for producing a panel in accordance with any embodiment of the first aspect of the invention. The method comprises the steps of:
supplying a substrate provided with a decor layer, and optionally a transparent layer, preferably provided with a transparent polyvinyl chloride layer,
   optionally, application of an adhesive layer,
   application of a lacquer, wherein the lacquer comprises antimicrobial additives and optionally photoinitiators,
   at least partial curing of the lacquer by means of UV irradiation or electron beam.

In this method, is preferably at least partially cured by means of an excimer light source under an inert atmosphere.

More preferably, after the partial curing of the lacquer by means of the excimer light source, the lacquer is further cured by means of UV irradiation, preferably by means of UV lamps.

A method wherein the lacquer comprises less than 5% by weight of matting agents (and more preferably less than 2% by weight of a matting agent; and more preferably less than 1% by weight of a matting agent) is specifically preferred. More preferable is a method wherein the decorative panel that is obtained has a gloss value lower than 10; and more preferably lower than 5. Such panels provide a favorable imitation of wood, natural stone, or a ceramic panel. The reason is that the low gloss value of the lacquer prevents a synthetic appearance. The low amount of matting agent – or even the absence of a matting agent – ensures that the strength of the acrylate matrix of the lacquer is maintained. This provides a durable lacquer and a durable cover layer. The strong, sealed acrylate matrix also provides easy and favorable cleanability of the surface of the decorative panel. The above-mentioned low amount of matting agents – and preferably the absence thereof – provides a synergistic advantage by means of which the antimicrobial action of the antimicrobial additive is improved and/or by means of which smaller amounts of antimicrobial additives are needed. Matting agents and open pores in the acrylate matrix that arise due to a high amount of matting agents can contain dirt and impurities; such dirt and/or impurities can stimulate microbial growth.

After the application of the flowable lacquer, the brief surface curing of the lacquer by means of an excimer light source ensures that crimping stresses at the surface of the lacquer occur that cause the formation of a microtexture (and the low gloss value). The excimer light source is immediately followed by a UV curing step, wherein the lacquer is cured in further depth, while the microstructure that provides the low gloss value is maintained.

Preferably, the lacquer comprises (meth)acrylate oligomers and/or (meth)acrylate monomers. (Meth)acrylate refers to acrylate and/or methacrylate.

Preferably, the lacquer comprises less than 5% by weight of a matting agent, and more preferably, the lacquer comprises less than 2% by weight of a matting agent; and more preferably, the lacquer comprises less than 1% by weight of a matting agent.

The third aspect of the invention is a method for producing a decorative panel, optionally for producing a panel in accordance with any embodiment of the first aspect of the invention. The method comprises the steps of:
supplying a substrate provided with a decor layer, and optionally a transparent layer, preferably a transparent polyvinyl chloride layer,
optionally, application of an adhesive layer,
application of a lacquer, wherein the lacquer comprises (meth)acrylate oligomers and/or (meth)acrylate monomers, wherein the lacquer comprises antimicrobial additives, optionally wherein the lacquer comprises more than 5% by weight – and preferably more than 7% by weight, and more preferably more than 10% by weight – of matting agents, and optionally photoinitiators,
at least partial curing of the lacquer by means of UV irradiation.

The fourth aspect of the invention is a method for producing a decorative panel, optionally for producing a panel in accordance with any embodiment of the first aspect of the invention. The method comprises the steps of:
supplying a substrate provided with a decor layer, and optionally a transparent layer, preferably a transparent polyvinyl chloride layer,
optionally, application of an adhesive layer,
application of a lacquer, wherein the lacquer comprises (meth)acrylate oligomers and/or (meth)acrylate monomers, wherein the lacquer comprises antimicrobial additives, and optionally thermoinitiators,
at least partial curing of the lacquer by means of a hot pressing treatment.

Optionally, this pressing treatment is carried out by means of a structured pressing surface, wherein a relief is formed in the surface of the decorative panel.

The fifth aspect of the invention relates to a decorative panel, wherein the decorative panel comprises a substrate and a top layer, wherein the top layer comprises a decor layer and a wear layer, wherein the wear layer comprises a paper layer impregnated with melamine resin, wherein the wear layer comprises antimicrobial additives. Decorative panels in accordance with the fifth aspect of the invention provide antimicrobial activity that is long-lasting and does not depend on the conditions of use and environmental conditions.

Optionally, the decor layer comprises a printed paper layer impregnated with melamine resin or acrylate resin.

In a preferred embodiment of the fifth aspect of the invention, the antimicrobial additives in the wear layer are selected from one or more of particles comprising silver components (such as particles comprising silver phosphate, more preferably silver phosphate glass particles), quaternary ammonium salts, quaternary ammonium groups built into the melamine resin of the wear layer, particles or additives that comprise quaternary ammonium groups, metallic silver particles, silver salts, silver complexes, silver chelates, copper salts, copper and alloys thereof (such as brass, bronze, copper-nickel, copper-nickel-zinc), zinc oxide, essential oils, oleoresins (such as linalool or thymol), polybiguanides, chitosan, isothiazolinone, antibiotics, or trichloromethylsulfenyl-containing fungicides, silver adsorbed to silicon oxide, silver chloride adsorbed to titanium dioxide, silver nitrate, silver sodium hydrogen zirconium phosphate, silver zinc zeolite, silver copper zeolite, silver phosphate glass, and silver borosilicate glass.

In a preferred embodiment of the fifth aspect of the invention, the wear layer comprises antimicrobial additives both above and below its paper layer. More preferably, the concentration of antimicrobial additives in the wear layer is substantially the same above and below the paper layer of the wear layer. Such embodiments provide a highly long-lasting antimicrobial effect, even in wear of the floor panels.

The sixth aspect of the invention relates to a decorative panel. The decorative panel comprises a substrate and a top layer, wherein the top layer comprises a decor layer and a wear layer, wherein the decor layer comprises a printed paper layer impregnated with melamine resin or acrylate resin, wherein the decor layer comprises antimicrobial additives. Decorative panels in accordance with the sixth aspect of the invention provide antimicrobial activity that is long-lasting and does not depend on the conditions of use and environmental conditions.

Optionally, the wear layer comprises a paper layer impregnated with melamine resin.

Optionally, the decorative panel of the sixth aspect of the invention is a decorative panel in accordance with any embodiment of the fifth aspect of the invention.

In a preferred embodiment of the sixth aspect of the invention, the antimicrobial additives in the decor layer are selected from one or more of particles comprising silver components (such as particles comprising silver phosphate, more preferably silver phosphate glass particles), quaternary ammonium salts, quaternary ammonium groups built into the matrix of the melamine resin of the decor layer, particles or additives that comprise quaternary ammonium groups, metallic silver particles, silver salts, silver complexes, silver chelates, copper salts, copper and alloys thereof (such as brass, bronze, copper-nickel, copper-nickel-zinc), zinc oxide, essential oils, oleoresins (such as linalool or thymol), polybiguanides, chitosan, isothiazolinone, antibiotics, or trichloromethylsulfenyl-containing fungicides, silver adsorbed to silicon oxide, silver chloride adsorbed to titanium dioxide, silver nitrate, silver sodium hydrogen zirconium phosphate, silver zinc zeolite, silver copper zeolite, silver phosphate glass, and silver borosilicate glass.

In a preferred embodiment of the sixth aspect of the invention, the decor layer comprises antimicrobial additives both above and below its paper layer, more preferably wherein the concentration of antimicrobial additives in the decor layer is substantially the same above and below the paper layer of the decor layer.

In a preferred embodiment of a decorative panel that combines the fifth aspect of the invention with the sixth aspect of the invention, the antimicrobial additives in the wear layer are the same as the antimicrobial additives in the decor layer. If antimicrobial additives are present in both the wear layer and the decor layer, a longer-lasting antimicrobial effect is achieved, because even if the wear layer is worn down to a great extent, antimicrobial properties are still always present over the entire surface of the decorative panel due to the antimicrobial additives in the decor layer.

Preferably, the wear layer comprises particles that increase the wear resistance, and preferably, these particles are selected from one or more of nanosilicate, aluminum oxide – for example in the form of corundum – and diamond, more preferably synthetic diamond. This provides a synergistic effect for the durability of the antimicrobial action. As the wear layer will wear more slowly, the antimicrobial effect is maintained for a longer time, and the antimicrobial additives are active in a more phased manner.

In a preferred embodiment, the wear layer, over its entire thickness, comprises particles that increase the wear resistance only between its paper layer and the side facing the decor layer.

In a preferred embodiment, the wear layer comprises, both between its paper layer and the side facing the decor layer and between its paper layer and the side facing away from the paper layer, particles that increase the wear resistance, wherein preferably these particles, between the paper layer and the side facing away from the paper layer, are on average finer than the particles between the paper layer and the side facing the decor layer.

In preferred embodiments of the fifth aspect of the invention and/or the sixth aspect of the invention, the substrate comprises or is a wood-based substrate – preferably wherein the wood-based substrate is or comprises a wood fiberboard, for example an MDF (medium density fiberboard) panel, an HDF (high density fiberboard) panel, or a chipboard – or a thermoplastic panel – for example a polyvinyl chloride-based panel –, or is or comprises a mineral panel - for example a magnesium oxide board or a fiber cement board or a fiber plaster board or a silicate board or a mineral fiber board (e.g. bonded with a resin, for example a synthetic resin).

In preferred embodiments of the fifth aspect of the invention and/or the sixth aspect of the invention, the substrate is composed of or the substrate comprises a wood fiberboard – for example an MDF panel or an HDF panel –, wherein the wood fiberboard has an average density that is larger than 800 kg per cubic meter, and wherein the wood fiberboard on both surfaces of the wood fiberboard shows a higher density that is at least 110% of the average density.

In preferred embodiments of the fifth aspect of the invention and/or the sixth aspect of the invention, the panel comprises a balance layer on the other side of the panel from the top layer, wherein the balance layer comprises a paper layer impregnated with melamine resin.

Preferably, the balance layer comprises antimicrobial additives. In such panels, mold formation and bacterial growth are prevented from occurring under a covering configured with such panels. Mold formation and bacterial growth might occur if the underside of the panels were moist.

More preferably, the antimicrobial additives in the balance layer are selected from one or more of particles comprising silver components (such as particles comprising silver phosphate, more preferably silver phosphate glass particles), quaternary ammonium salts, quaternary ammonium groups built into the melamine resin of the balance layer, particles or additives that comprise quaternary ammonium groups, metallic silver particles, silver salts, silver complexes, silver chelates, copper salts, copper and alloys thereof (such as brass, bronze, copper-nickel, copper-nickel-zinc), zinc oxide, essential oils, oleoresins (such as linalool or thymol), polybiguanides, chitosan, isothiazolinone, antibiotics, or trichloromethylsulfenyl-containing fungicides, silver adsorbed to silicon oxide, silver chloride adsorbed to titanium dioxide, silver nitrate, silver sodium hydrogen zirconium phosphate, silver zinc zeolite, silver copper zeolite, silver phosphate glass, and silver borosilicate glass.

Preferably, the wear layer comprises no titanium dioxide. It is therefore advantageous for antimicrobial additives in the wear layer also not to comprise titanium dioxide. Titanium dioxide in the wear layer would reduce the transparency of the wear layer; this is disadvantageous for the visual observation of the decor represented by the decor layer.

In preferred embodiments of the fifth aspect of the invention and/or the sixth aspect of the invention, the surface of the panel comprises a texture embossed into the decorative surface of the panel, wherein the deepest depressions of this texture also comprise the decor layer and the wear layer, wherein the decor layer and/or the wear layer also comprise(s) antimicrobial additives in these deepest depressions of the texture. Texture in the surface of a panel may comprise impurities. Such impurities may comprise for example molds or microbes that can grow. The presence of antimicrobial additives even in the deepest depressions of the texture in the surface of the panel prevents this in an effective and efficient manner.

In preferred embodiments of the fifth aspect of the invention and/or the sixth aspect of the invention, the surface of the panel comprises a texture embossed into the decorative surface of the panel, wherein at least a portion of the indentations are pressed into the substrate, wherein the indentations that are pressed into the substrate comprise the decor layer and the wear layer at their bottom, wherein the decor layer and/or the wear layer also comprise(s) antimicrobial additives at this bottom. Texture in the surface of a panel may comprise impurities. Such impurities can for example comprise molds or microbes that can grow. The presence of antimicrobial additives even in the depressions of the texture in the surface of the panel prevents this in an effective and efficient manner. In these embodiments, this is effectively the case of a structure pressed into the surface of the panel, and not of lowered edges - such as bevels or other chamfered edges - at the edges of the panel, which of course may also be present.

In preferred embodiments of the fifth aspect of the invention and/or the sixth aspect of the invention, the panel is provided on at least a portion of its side edges with a lower edge area, such as a bevel or other chamfered edge, wherein the lower edge area is provided over at least a portion thereof with the decor layer and the wear layer. This means that there is therefore also at least one layer with antimicrobial additives present on the lower edge areas. This is advantageous because these lower edge areas can rapidly become soiled, and microbial contamination could therefore be present sooner.

Such lower edge areas can for example be pressed into the decorative panel or can be formed via a mechanical treatment – e.g. a milling treatment.

The seventh aspect of the invention relates to a decorative panel, wherein the decorative panel comprises a substrate and a top layer, wherein the top layer comprises a decor layer and a wear layer, wherein the panel, on at least one of its side edges – and preferably on two opposite side edges and more preferably on all of its side edges – comprises, over at least a portion of this side edge, an impregnating agent or a coating applied to this side edge, wherein this impregnating agent or this coating comprises antimicrobial additives. The side edges of the decorative panel may be sensitive to the penetration of moisture and/or impurities. For this reason, it is advantageous to have antimicrobial additives on the side edges.

Optionally, the decorative panel in accordance with the seventh aspect of the invention is a decorative panel in accordance with the fifth aspect of the invention and/or in accordance with the sixth aspect of the invention.

In a preferred embodiment of the seventh aspect of the invention, the decor layer comprises a printed paper layer impregnated with melamine resin or acrylate resin, wherein the wear layer comprises a paper layer impregnated with melamine resin.

In a preferred embodiment of the seventh aspect of the invention, the antimicrobial additives in the impregnating agent or in the coating are selected from one or more of particles comprising silver components (such as particles comprising silver phosphate, more preferably silver phosphate glass particles), quaternary ammonium salts, quaternary ammonium groups incorporated into the impregnating agent or the coating, particles or additives that comprise quaternary ammonium groups, metallic silver particles, silver salts, silver complexes, silver chelates, copper salts, copper and alloys thereof (such as brass, bronze, copper-nickel, copper-nickel-zinc), zinc oxide, essential oils, oleoresins (such as linalool or thymol), polybiguanides, chitosan, isothiazolinone, antibiotics, or trichloromethylsulfenyl-containing fungicides, silver adsorbed to silicon oxide, silver chloride adsorbed to titanium dioxide, silver nitrate, silver sodium hydrogen zirconium phosphate, silver zinc zeolite, silver copper zeolite, silver phosphate glass, and silver borosilicate glass.

In a preferred embodiment of the seventh aspect of the invention, the impregnating agent or the coating provides the side edge(s) of the panel with water-repellent properties over at least a portion of the height of the side edge(s). This improves the antimicrobial action because moisture that could comprise microbes or bacteria or stimulate their growth is prevented from penetrating at the side edges of the decorative panel.

In a preferred embodiment of the seventh aspect of the invention, the impregnating agent or the coating comprises one or more of an acrylate, a fluoroacrylate, a fluorinated copolymer, an epoxy, acetic anhydride, or an alkyd. The antimicrobial additives can be efficiently brought into such products so that the application of the antimicrobial additives can be carried out in a simple manner.

The eighth aspect of the invention relates to a decorative panel, wherein the decorative panel comprises a wood-based decor layer to which at least one lacquer layer is applied, wherein the at least one lacquer layer comprises at least one lacquer layer that comprises antimicrobial additives. Decorative panels in accordance with the eighth aspect of the invention provide antimicrobial activity that is long-lasting.

In preferred embodiments of the eighth aspect of the invention, the antimicrobial additives in the lacquer layer are selected from one or more of particles comprising silver components (such as particles comprising silver phosphate, more preferably silver phosphate glass particles), quaternary ammonium salts, quaternary ammonium groups built into the lacquer layer, particles or additives that comprise quaternary ammonium groups, metallic silver particles, silver salts, silver complexes, silver chelates, copper salts, copper and alloys thereof (such as brass, bronze, copper-nickel, copper-nickel-zinc), zinc oxide, essential oils, oleoresins (such as linalool or thymol), polybiguanides, chitosan, isothiazolinone, antibiotics, or trichloromethylsulfenyl-containing fungicides, silver adsorbed to silicon oxide, silver chloride adsorbed to titanium dioxide, silver nitrate, silver sodium hydrogen zirconium phosphate, silver zinc zeolite, silver copper zeolite, silver phosphate glass, and silver borosilicate glass.

In preferred embodiments of the eighth aspect of the invention, multiple lacquer layers are applied to the wood-based decor layer; wherein the upper lacquer layer comprises antimicrobial additives. Such embodiments provide a highly efficient antimicrobial action.

In preferred embodiments of the eighth aspect of the invention, multiple lacquer layers are applied to the wood-based decor layer, wherein at least one lacquer layer comprises particles that increase the wear resistance – preferably selected from one or more of nanosilicate, aluminum oxide - for example in the form of corundum – and diamond, more preferably synthetic diamond; wherein one or more of the lacquer layers closer to the surface of the panel than the at least one lacquer layer comprising particles that increase the wear resistance comprise(s) antimicrobial additives.

Preferably, the lacquer layer or lacquer layers comprising particles that increase the wear resistance does/do not comprise comprise any antimicrobial additives.

Preferably, the lacquer layer or lacquer layers comprising particles that increase the wear resistance also comprise(s) antimicrobial additives. As lacquer layers that do not comprise wear-resistant particles also comprise antimicrobial additives, the antimicrobial additives in the lacquer layers comprising wear-resistant particles are preferably of the same type as in lacquer layers that do not comprise any wear resistance-increasing additives.

Embodiments wherein the lacquer layer or multiple lacquer layers comprising wear-resistant particles (also) comprise(s) antimicrobial additives are advantageous in that the antimicrobial effect is longer-lasting, because even in advanced wear of the decorative panel, antimicrobial activity is still obtained.

In preferred embodiments of the eighth aspect of the invention, the decorative panel is a parquet panel, or a multiple-layer parquet panel, or a composite parquet panel, or a so-called “engineered wood” panel.

In preferred embodiments of the eighth aspect of the invention, the wood-based decor layer is a wood veneer layer or a wood layer thicker than a veneer layer. Preferably, the veneer layer is thinner than 2.5 mm, more preferably, the veneer layer is between 0.4 and 0.8 mm thick. Preferably, wood-based decor layers are thicker than veneer thicker than 2.5 mm.

The substrate in such embodiments can be wood-based, for example one or more layers of wood, but can also be a thermoplastic substrate (for example based on polyvinyl chloride), or a chipboard or a wood fiberboard or a mineral or mineral panel.

The ninth aspect of the invention relates to a decorative panel, wherein the panel is provided on at least a portion of its side edges with a lower edge area, such as a bevel or other chamfered edge, wherein the lower edge areas are provided with a lacquer layer – preferably an acrylate lacquer layer, a polyurethane lacquer layer, or an alkyd lacquer layer –, wherein this lacquer layer comprises antimicrobial additives. Preferably, this lacquer layer is a colored lacquer layer. As the chamfered edges may become soiled more easily and are more difficult to clean, there is a risk of impurities and mold and/or bacterial growth on these lower edge areas. For this reason, it is advantageous for these lower edge areas to be provided with a lacquer layer that comprises antimicrobial additives in order to prevent microbial activity and/or mold growth on the lower edge areas.

Optionally, the decorative panel in accordance with the ninth aspect of the invention is a panel in accordance with any embodiment of one or more of the first aspect of the invention, the fifth aspect of the invention, the sixth aspect of the invention, the seventh aspect of the invention, or the eighth aspect of the invention.

In a preferred embodiment of the ninth aspect of the invention, the antimicrobial additives in the lacquer layer on the lower edge areas are selected from one or more of particles comprising silver components (such as particles comprising silver phosphate, more preferably silver phosphate glass particles), quaternary ammonium salts, quaternary ammonium groups built into the matrix of the lacquer, particles or additives that comprise quaternary ammonium groups, metallic silver particles, silver salts, silver complexes, silver chelates, copper salts, copper and alloys thereof (such as brass, bronze, copper-nickel, copper-nickel-zinc), zinc oxide, essential oils, oleoresins (such as linalool or thymol), polybiguanides, chitosan, isothiazolinone, antibiotics, or trichloromethylsulfenyl-containing fungicides, silver adsorbed to silicon oxide, silver chloride adsorbed to titanium dioxide, silver nitrate, silver sodium hydrogen zirconium phosphate, silver zinc zeolite, silver copper zeolite, silver phosphate glass, and silver borosilicate glass.

In a preferred embodiment of the ninth aspect of the invention, the decorative panel comprises a decor layer and a wear layer. More preferably, the lower edge areas, at most partially, comprise the decor layer and the wear layer; more preferably, the lower edge areas are milled lower edge areas.

Even if the decorative panel comprises a decor layer that comprises antimicrobial additives and/or if the decorative panel comprises a wear layer that comprises antimicrobial additives, the lower edge areas are critical zones, particularly if they do not or only partially comprise the decor layer and the wear layer. For this reason, it is definitely advantageous in such situations to provide a lacquer layer on the lower edge areas that comprises antimicrobial additives.

In a preferred embodiment of the ninth aspect of the invention, the decorative panel comprises a decor layer, a wear layer and a substrate, wherein the substrate comprises one or more of: a wood fiberboard, a chipboard, one or more layers of wood, one or more thermoplastic layers - for example one or more polyvinyl chloride layers - which may or may not comprise fillers, a mineral panel such as for example a magnesium oxide board or a fiber cement board or a fiber plaster board or a silicate board or a mineral fiber board (e.g. bonded with a resin) or is composed thereof.

In a preferred embodiment of the ninth aspect of the invention, the lacquer layer on the lower edge areas is not or only minimally applied to the upper surface of the decorative panel.

In preferred embodiments of the fifth aspect of the invention and/or the sixth aspect of the invention and/or the seventh aspect of the invention and/or the eighth aspect of the invention and/or the ninth aspect of the invention, the decorative panel is provided at a first pair of opposite edges with coupling components, substantially in the form of male and female coupling components, for coupling two such panels to each other at their first pair of opposite edges, wherein the coupling components are provided with interlocking components, wherein the coupling components together with the interlocking components provide interlocking in a coupled state of two such panels in the direction perpendicular to the surface of the coupled panels, as well as in the direction in the plane of the panels and perpendicular to the coupled edges. Such embodiments allow panels to be easily and quickly installed to produce a floating floor covering.

Preferably, the coupling components of the first pair of opposite edges are provided such that two such panels can be coupled at their first pair of opposite edges by means of an angling movement and/or by means of a sliding movement with a snap effect parallel to the surface of the panels.

Preferably, the coupling components are substantially produced from the material of the substrate.

Preferably, the coupling components of the first pair of opposite edges are substantially configured in the form of a tongue and a groove, wherein the tongue and the groove are provided with interlocking components that in a coupled state of two such panels at their first pair of opposite edges provide interlocking in the direction in the plane of the panels and perpendicular to the coupled edges, wherein the groove is delimited by an upper lip and a lower lip, wherein the lower lip protrudes farther in a distal direction than the upper lip, and wherein the part of the lower lip that protrudes farther in a distal manner than the upper lip comprises an interlocking component in the form of an upward facing interlocking component.

More preferably, the coupling components of the first pair of opposite edges are provided such that two such panels can be coupled at their first pair of opposite edges by means of an angling movement and/or by means of a sliding movement with a snap effect parallel to the surface of the panels, and/or by means of a substantially downward movement in the direction perpendicular to the plane of the panels.

Preferably, the decorative panel is provided on a second pair of opposite edges with coupling components, substantially in the form of male and female coupling components, for coupling two such panels to each other at their second pair of opposite edges, wherein the coupling components are provided with interlocking components, wherein the coupling components and the interlocking components provide interlocking in a coupled state of two such panels in the direction perpendicular to the surface of the coupled panels, as well as in the direction in the plane of the panels and perpendicular to the coupled edges, wherein the coupling components of the second pair of opposite edges are provided such that two such panels can be coupled at their second pair of opposite edges by means of an angling movement and/or by means of a sliding movement with a snap effect parallel to the surface of the panels, and/or by means of a substantially downward movement in the direction perpendicular to the plane of the panels.

In preferred embodiments of the fifth aspect of the invention and/or the sixth aspect of the invention and/or the seventh aspect of the invention and/or the eighth aspect of the invention and/or the ninth aspect of the invention, the decorative panel is rectangular, whether oblong or square.

In preferred embodiments of the fifth aspect of the invention and/or the sixth aspect of the invention and/or the seventh aspect of the invention and/or the eighth aspect of the invention and/or the ninth aspect of the invention, the decorative panel is a floor panel, a wall panel, or a ceiling panel.

In preferred embodiments of the fifth aspect of the invention and/or the sixth aspect of the invention and/or the seventh aspect of the invention and/or the eighth aspect of the invention and/or the ninth aspect of the invention, the antimicrobial additives have virus-killing activity. This means that the antimicrobial agents ensure that any viruses present on the surface of the decorative panel have a shorter life than they would if the decorative panel did not comprise these antimicrobial additives.

In the different aspects of the invention, the use of silver components that comprise silver in ionic form provides the specific advantage that such antimicrobial additives do not leach out, and thus maintain their antimicrobial action over time, even in frequent wet cleaning of the decorative panels. In the different aspects of the invention, the use of silver phosphate glass particles is particularly advantageous, because the silver ions that have the antimicrobial action are efficiently embedded in the silver phosphate glass, and the silver phosphate glass is then in turn efficiently embedded in the lacquer. In this manner, silver ions are released in a controlled manner that provide the antimicrobial action, so that the microbial action is maintained in a very long-lasting manner. As silver phosphate glass particles are very efficient in this manner, only a small amount thereof is necessary.

When layers that comprise antimicrobial additives follow one another at or near the surface of the decorative panel, a longer-lasting antimicrobial action is obtained, particularly if wear occurs on the surface of the panel. On the other hand, a better antimicrobial effect is also achieved on the side edges of the panel when antimicrobial additives are comprised not only on the outermost surface of the panel.

When different layers of the decorative panel comprise antimicrobial additives, it is also advantageous for these additives to be the same. This provides various advantages depending on the position of the layers.

When “comprises antimicrobial additives” is stated, this does not necessarily mean that different kinds of antimicrobial additives are used. The plural refers to the fact that an amount of a specified type of antimicrobial additive is used.

The tenth aspect of the invention relates to a floor covering, wherein this floor covering comprises decorative panels in accordance with any embodiment of the first aspect of the invention and/or in accordance with any embodiment of the fifth aspect of the invention and/or in accordance with any embodiment of the sixth aspect of the invention and/or in accordance with any embodiment of the seventh aspect of the invention and/or in accordance with any embodiment of the eighth aspect of the invention and/or in accordance with any embodiment of the ninth aspect of the invention.

The eleventh aspect of the invention relates to a floor covering, wherein the floor covering is configured like the decorative panels of the first aspect of the invention. An example of such a floor covering is a floor covering that is composed of or comprises so-called “sheet vinyl” (vinyl on a roll). A floor covering such as in the eleventh aspect of the invention thus comprises a substrate, a decor layer, and a cover layer. The cover layer comprises a lacquer or is composed of a lacquer. The lacquer comprises antimicrobial additives; wherein the lacquer comprises an acrylate matrix and/or a methacrylate matrix. Embodiments of the eleventh aspect of the invention are the same as the embodiments described for the decorative panel of the first aspect of the invention.

The twelfth aspect of the invention is a method in accordance with any embodiment of the second, third or fourth aspect of the invention, with the difference that instead of a decorative panel, a vinyl on a roll (“sheet vinyl”) is produced.

In order to better illustrate the features of the invention, several preferred embodiments are described below, as examples that are by no means limitative, with reference to the attached drawings, wherein:

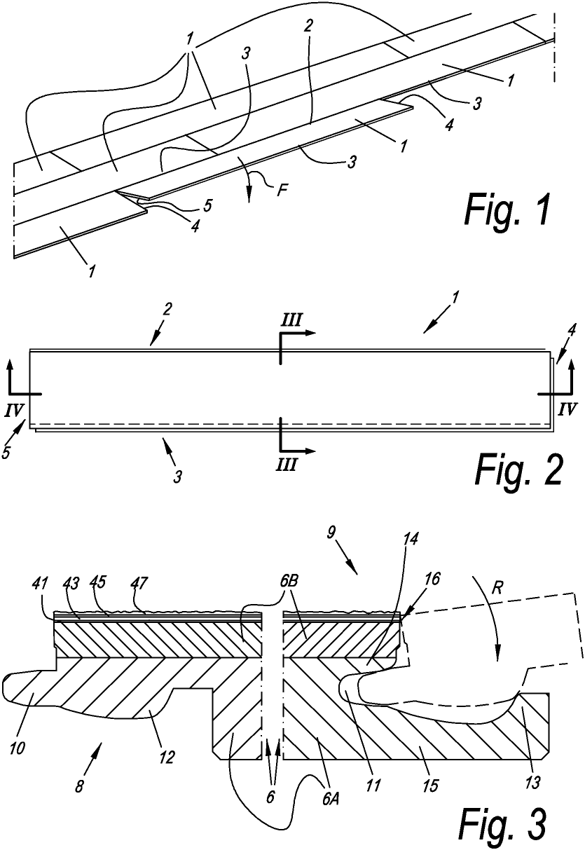

FIG. 1 shows a partially installed floor covering composed of decorative floor panels in accordance with an example of the invention,

FIG. 2 shows a top view of a decorative floor panel in accordance with an example of the invention such as used in the floor covering of FIG. 1,

FIG. 3 shows the section of the decorative floor panel along line III-III of FIG. 2,

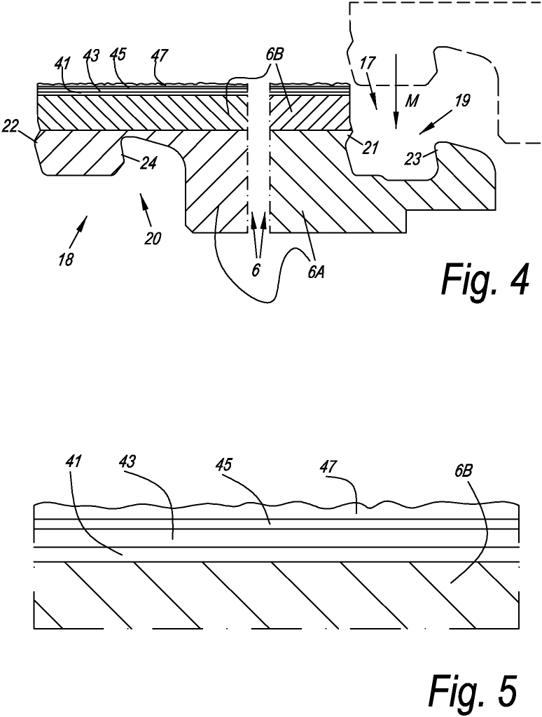

FIG. 4 shows the section of the decorative floor panel along line IV-IV in FIG. 2,

FIG. 5 shows a larger-scale view of the structure of the upper part of the decorative panel of FIGS. 1-4,

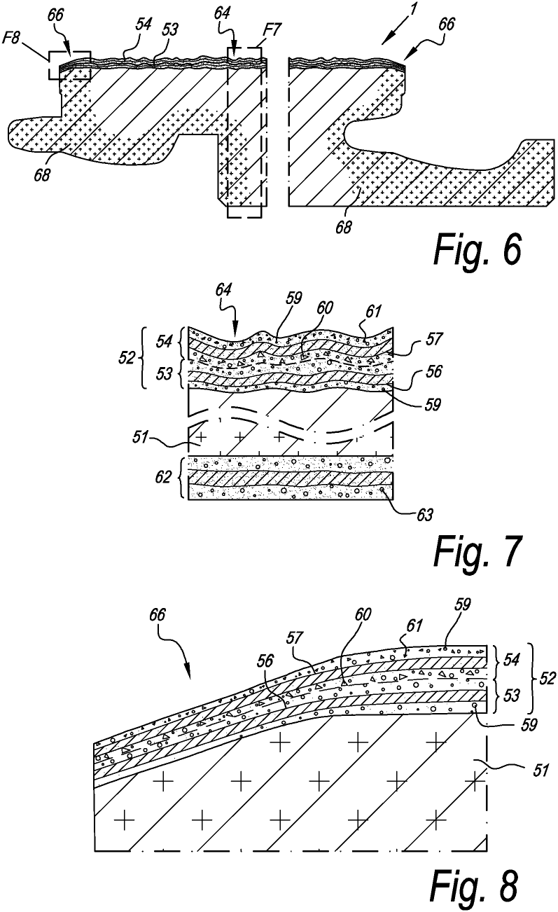

FIG. 6 illustrates a decorative panel in accordance with aspects of the invention,

FIG. 7 shows a detail of the decorative panel of FIG. 6,

FIG. 8 shows a detail of the decorative panel of FIG. 6,

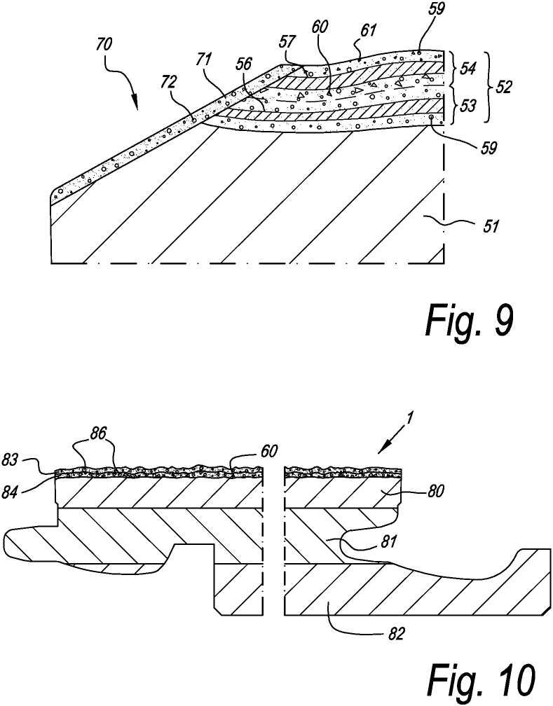

FIG. 9 shows an alternative embodiment of chamfered edges of a decorative panel in accordance with the invention, and

FIG. 10 illustrates a decorative panel in accordance with aspects of the invention.

A decorative panel in accordance with the invention can be produced in the following manner. A printed polyvinyl chloride film, and on top of this, a transparent polyvinyl chloride film are laminated onto a polyvinyl chloride substrate.

An example of a transparent polyvinyl chloride film that can be used has the following composition: polyvinyl chloride, a plasticizer, stabilizers, process auxiliaries, and optionally 0.1-2% by weight of a biocide. Reported examples of biocides used in the transparent polyvinyl chloride film may include trichloromethylsulfenyl-containing fungicides or thiabendazole.

Optionally, a relief can be embossed into the transparent polyvinyl chloride film, preferably during lamination.

In order to increase adhesion, an adhesive layer is applied to this laminate – and thus to the transparent polyvinyl chloride layer. Such an adhesive layer can for example be applied as a water-based acrylate, a solvent-based acrylate, or a 100% acrylate primer. For example, 5-20 g (expressed as solid matter) of adhesive layer per square meter is applied. More preferably, 6-12 g (expressed as solid matter) of adhesive layer per square meter is applied. Optionally, the adhesive layer comprises antimicrobial additives, for example silver phosphate water glass, preferably in an amount of 0.1-4% by weight based on the dry matter of the adhesive layer; and more preferably in an amount of 0.2-2% by weight based on the dry matter of the adhesive layer.

The adhesive layer is then gelled, for example by means of UV lamps, optionally preceded by thermal treatment.

After this, the lacquer is applied. An example of a lacquer that can be used comprises the following composition:
20-70% by weight of acrylate and/or methacrylate oligomer. This can be composed of one or more of an acrylate, a urethane acrylate, a polyester acrylate, or an epoxy acrylate; or similar methacrylates;
   1-50% by weight of monomers (preferably acrylate and/or methacrylate monomers), for example one or more of trimethylol propane triacrylate, dipropylene glycol diacrylate, 1,6-hexane diol diacrylate, 3,3,5-trimethyl cyclohexyl acrylate, acryloyl morpholine, 3-vinyl-5-methyl-2-oxazolidinone;
   0.1-4% by weight of silver phosphate glass;
   no matting agent, or optionally 0.1-5% by weight of a matting agent;
   0.1-10% by weight of wear-resistant particles, such as for example corundum (this is a form of aluminum oxide), nanosilica or microdiamond;
   0.1-5% by weight of a photoinitiator;
   optionally 0.1-5% by weight of a thermoinitiator;
   optionally 0.1-5% by weight of dual-cure crosslinking agents such as isocyanates or carbodiimide;
   optionally 0.1-5% by weight of silicone and/or fluorine-based polymers.

For example, 5-20 g per square meter of lacquer can be applied in one or in two steps. After this, the lacquer is cured. This can take place in various ways, for example via options A, B, and C. However, option A is preferred.

In option A, the lacquer is irradiated under an inert atmosphere with an excimer light source having a wavelength of 172 nm, which cures the lacquer on the surface. This produces crimping stresses at the surface of the lacquer which provide a microtexture (and a low gloss value). The excimer light source is immediately followed by a UV curing step, wherein the lacquer is cured in further depth. The process in accordance with option A makes it possible, even with few or no matting agents in the lacquer, to achieve a low gloss value of the lacquer layer.

In option B, the lacquer is cured with standard UV lamps. In order to obtain a low gloss value, for example a silk matt gloss with a gloss value lower than 20; or a matt lacquer layer with a gloss value lower than 10, such lacquer must contain a sufficient amount of a matting agent, more than 7% by weight or even more than 10% by weight.

In option C, the gloss value of the lacquer is determined by polymerizing the lacquer by means of a pressing treatment with a structured press, optionally also followed by thermal or UV curing in order to completely cure the lacquer layer.

FIG. 1 shows a partially installed floor covering composed of decorative floor panels in accordance with an example of the invention. These decorative floor panels 1 comprise coupling components on the first pair of opposite edges 2, 3 - these are the long edges of the rectangular and oblong floor panels. The coupling components are substantially configured in the form of male coupling components and female coupling components for coupling two such panels to each other at their first pair of opposite edges. The coupling components of the first pair of opposite edges 2, 3 are configured such that two such panels can be coupled to each other at their first pair of opposite edges by means of an angling movement.

The second pair of opposite edges 4, 5 – which in this case are the short edges – are also provided with coupling components in the form of male coupling components and female coupling components in order to couple two such panels 1 to each other at their second pair of opposite edges 4, 5. The coupling components at the second pair of opposite edges 4, 5 are configured such that two such panels 1 can be coupled to each other at their second pair of opposite edges 4, 5 by means of a substantially downward movement in the direction perpendicular to the plane of the floor covering. Such a downward movement is possible with coupling components of the so-called “push-down,” “push-lock,” or “drop” types.

Thanks to the specific configurations of the coupling components, the decorative panel 1, starting from an inclined position, can be coupled in a single movement F at its long edge 2 and also at its short edge 5 to already-installed floor panels 1. This installation method of floor panels is known as “fold-down” installation. The “fold-down” movement F makes it possible to install decorative floor panels in accordance with the invention in a rapid and efficient manner.

FIG. 2 shows a top view of a decorative floor panel in accordance with an example of the invention such as used in the floor covering of FIG. 1. The decorative panel 1 is rectangular and oblong and comprises a first pair of opposite edges 2, 3 that form the long edges of the panel and a second pair of opposite edges 4, 5 that form the short edges of the panel. The panel of the example comprises a printed decorative pattern, and said decorative pattern is not shown in FIGS. 1 and 2.

FIG. 3 shows the section of the decorative floor panel along line III-III of FIG. 2. The floor panel 1 comprises a multilayer substrate 6, a decor layer – in the form of a printed polyvinyl chloride film 41 – and a cover layer. The cover layer comprises a transparent polyvinyl chloride film 43, an adhesive layer 45, and a lacquer 47 that comprises antimicrobial additives. These can be configured as in the example described above. FIG. 5 shows a larger-scale view of the structure of the upper part of the decorative panel, wherein the second layer 6B of the substrate, the printed polyvinyl chloride film 41, the transparent polyvinyl chloride film 43, the adhesive layer 45, and the lacquer 47 that comprises antimicrobial additives are shown. The irregular surface of the lacquer 47 provides a low gloss value of the decorative panel. This can be achieved via option A of the above-mentioned ways of curing the lacquer.

In this example, the substrate is multi-layered. However, the substrate can also consist of only one polyvinyl chloride layer that may or may not be foamed and may or may not comprise fillers.

In the example, the substrate 6 comprises two layers. A first layer 6A and a second layer 6B. The first layer 6A can be produced based on polyvinyl chloride that comprises no plasticizers or comprises less than 20 phr of a plasticizer. The polyvinyl chloride of the first layer can be foamed and can comprise fillers, such as mineral fillers or wood-based fillers. This first layer 6A is a stiff layer. Such a described layer can also be the only layer of the substrate.

The multilayer substrate 6 of the example comprises a more flexible second layer 6B above the first layer 6A. This more flexible layer 6B is a polyvinyl chloride layer that comprises more than 20 phr of a plasticizer. This second layer 6B can comprise fillers such as mineral fillers or wood-based fillers.

Preferably, the first layer 6A forms at least half of the thickness of the decorative panel 1.

The first pair of opposite edges 2, 3 is provided with coupling components 8, 9 that allow two such panels at their first pair of opposite edges 2, 3 to be coupled to each other by means of an angling movement R around an axis parallel to the floor panel and parallel to the first pair of opposite edges 2, 3. The coupling components 8, 9 are substantially produced from material of the substrate 6, and in particular in the example from material of the first, stiffer layer 6A.

The coupling components 8, 9 of the first pair of opposite edges are substantially produced as a tongue 10 and a groove 11 that are provided with interlocking components 12, 13 which, in a coupled state of two such panels, prevent the panels from being slid away from each other in the plane of the panels in the direction perpendicular to the first pair of opposite edges 2, 3.

The groove 11 is delimited by an upper lip 14 and by a lower lip 15. The lower lip 15 extends in a distal direction farther than the distal end 16 of the upper lip 14. The lower lip 15 comprises an interlocking component 13 in the form of an upward facing interlocking component 13.

FIG. 4 shows the section of the decorative floor panel along line IV-IV in FIG. 2. The reference numbers in FIG. 4 have the same meaning as those in FIG. 3.

The second pair of opposite edges 4, 5 is provided with coupling components 17, 18 that allow two such panels 1 at their second pair of opposite edges to be coupled by means of a substantially vertical movement M in the direction perpendicular to the plane of the floor covering. The coupling components 17, 18 are configured as hook-shaped components 19, 20 that form an interlocking system that allows interlocking to occur in the plane of the floor panel and perpendicular to the second pair of coupled edges 4, 5. These coupling components 17, 18 comprise interlocking components 21, 22 and interlocking components 23, 24, each of which forms an interlocking system that allows interlocking to occur in the direction perpendicular to the plane of the coupled panels.

The coupling components 8, 9 on the first pair of opposite edges 2, 3; and the coupling components 17, 18 on the second pair of opposite edges 4, 5, allow such decorative panels to be installed in a floor covering by means of the “fold-down” installation technique F, as illustrated in FIG. 1.

FIG. 6 illustrates a decorative panel 1 in accordance with aspects of the invention in the same section as in FIG. 3. FIG. 7 shows a detail F7 of the panel of FIG. 6. The panel 1 of FIG. 6 is rectangular and oblong. As does the panel of FIG. 3, the panel of FIG. 6 comprises coupling components, and in the example these are configured as in the panel of FIG. 3.

The panel comprises a substrate 51 – for example a high density fiberboard (HDF) – and a top layer 52. The top layer 52 comprises a decor layer 53 and a wear layer 54. The decor layer 53 comprises a printed paper layer 56 impregnated with melamine resin. The wear layer comprises a paper layer 57 impregnated with melamine resin. Both the wear layer and the decor layer comprise antimicrobial additives 59, wherein the antimicrobial additives are comprised in the respective melamine resins. Both the decor layer 53 and the wear layer 54 comprise antimicrobial additives 59 above and below their respective papier layer, substantially in the same concentration above and below their respective paper layer.

The wear layer 54 comprises particles 60, 61 that increase the wear resistance. In the example, the wear layer 54 comprises such particles both above and below its paper layer 57. The particles 60 above the paper layer 57 are on average finer than the particles 61 below the paper layer 57.

The panel 1 comprises a balance layer 62 on the underside of the panel. The balance layer 62 comprises a paper layer impregnated with melamine resin. The balance layer 62 comprises antimicrobial additives 63.

In the example, the antimicrobial additives 59, 63 are the same in the decor layer, the wear layer, and the balance layer. This does not necessarily have to be the case in the invention. Moreover, these three layers do not all have to comprise antimicrobial additives.

The surface of the panel 1 comprises a texture embossed into the decorative surface of the panel. At least a part of the texture is embossed into the substrate 51. The deepest depressions 64 of this texture also comprise the decor layer 53 and the wear layer 54. The decor layer 53 and the wear layer 54 also comprise the antimicrobial additives 59 in these deepest depressions of the texture.

The panel 1 of the example of FIG. 6 comprises side edges with lower edge areas, more specifically pressed-in chamfered edges 66. FIG. 8 shows in detail these pressed-in chamfered edges 66 in accordance with F8 of FIG. 6. These pressed-in chamfered edges 66 comprise the decor layer 53 and the wear layer 54, so that antimicrobial additives 59 are also present on these pressed-in chamfered edges via the decor layer 53 and the wear layer 54.

The side edges of the panel 1 of FIG. 6 are impregnated with an impregnating agent 68 that makes the side edges water-repellent. In the example, this impregnating agent also comprises antimicrobial additives.

FIG. 9 shows – in the same view as in FIG. 8 – an alternative embodiment of chamfered edges of a decorative panel in accordance with the invention. In the example of FIG. 9, the chamfered edges 70 are chamfered edges milled on the side edges. These chamfered edges only partially comprise the decor layer and the wear layer. The chamfered edges 70 comprise a colored lacquer layer 71 that comprises antimicrobial additives 72.

The same reference numbers as in FIGS. 6-8 have the same meaning.

FIGS. 6-9 illustrate multiple aspects of the invention. However, the combination of these aspects is not essential in the framework of the invention; each of these aspects can occur separately.

FIG. 10 illustrates a decorative panel 1 in accordance with aspects of the invention. The panel 1 is a multiple-layer parquet panel. The panel comprises a decorative wood layer 80 on two other wood layers 81, 82. The decorative wood layer comprises lacquer layers 83, 84. In practice, a plurality of lacquer layers can be applied to the panel.

The upper lacquer layer 83 comprises antimicrobial additives. The underlying lacquer layer 84 comprises particles 60 that increase the wear resistance of the panel. In the example, both the upper lacquer layer 83 and the underlying lacquer layer 84 comprise antimicrobial additives 60. This is not necessary for the invention; in accordance with the invention, one or more lacquer layers may comprise antimicrobial additives. The other reference numbers have the same meaning as in FIGS. 3 and 6-9.

1-99. (canceled)

100. A decorative panel, wherein the decorative panel comprises a substrate, a decor layer and a cover layer,
wherein the substrate comprises one or more polyvinyl chloride layers or is composed thereof, optionally wherein one or more of these layers comprises a filler and/or other additives, optionally wherein one or more of the polyvinyl chloride layers is foamed;
wherein the decor layer comprises a printed polyvinyl chloride film;
wherein a transparent polyvinyl chloride film is applied to the printed polyvinyl chloride film;
wherein the cover layer comprises a transparent polyvinyl chloride film either with or without a relief;
wherein the cover layer comprises a lacquer or is composed thereof,
wherein the lacquer comprises antimicrobial additives;
wherein the lacquer comprises an acrylate matrix and/or a methacrylate matrix.

101. The decorative panel in accordance with claim 100, wherein the matrix of the lacquer is at least partially cured by means of UV irradiation and/or by means of electron beam.

102. The decorative panel as in claim 100, wherein the antimicrobial additives in the lacquer are selected from one or more of particles comprising silver components, particles comprising silver phosphate, silver phosphate glass particles, quaternary ammonium salts, quaternary ammonium groups built into the matrix of the lacquer, particles or additives that comprise quaternary ammonium groups, metallic silver particles, silver salts, silver complexes, silver chelates, copper salts, copper and alloys thereof, zinc oxide, essential oils, oleoresins, polybiguanides, chitosan, isothiazolinone, antibiotics, or trichloromethylsulfenyl-containing fungicides, silver adsorbed to silicon oxide, silver chloride adsorbed to titanium dioxide, silver nitrate, silver sodium hydrogen zirconium phosphate, silver zinc zeolite, silver copper zeolite, silver phosphate glass, and silver borosilicate glass.

103. The decorative panel as in claim 100, wherein the surface of the lacquer has a gloss value lower than 20.

104. The decorative panel as in claim 100, wherein the lacquer comprises less than 5% by weight of a matting agent.

105. The decorative panel as in claim 100, wherein the lacquer comprises particles that increase the wear resistance of the decorative panel, selected from one or more of nanosilicate, aluminum oxide and diamond.

106. The decorative panel as in claim 100, wherein the transparent polyvinyl chloride film comprises a biocide.

107. The decorative panel as in claim 100, wherein the antimicrobial additives have virus-killing activity.

108. A decorative panel, wherein the decorative panel comprises a substrate and a top layer,
wherein the top layer comprises a decor layer and a wear layer,
wherein the decor layer comprises a printed paper layer impregnated with melamine resin or with acrylate resin,
wherein the wear layer comprises a paper layer impregnated with melamine resin,
wherein the wear layer comprises antimicrobial additives.

109. The decorative panel as in claim 108, wherein the antimicrobial additives in the wear layer are selected from one or more of particles comprising silver components, particles comprising silver phosphate, silver phosphate glass particles, quaternary ammonium salts, quaternary ammonium groups built into the melamine resin of the wear layer, particles or additives that comprise quaternary ammonium groups, metallic silver particles, silver salts, silver complexes, silver chelates, copper salts, copper and alloys thereof, zinc oxide, essential oils, oleoresins, polybiguanides, chitosan, isothiazolinone, antibiotics, or trichloromethylsulfenyl-containing fungicides, silver adsorbed to silicon oxide, silver chloride adsorbed to titanium dioxide, silver nitrate, silver sodium hydrogen zirconium phosphate, silver zinc zeolite, silver copper zeolite, silver phosphate glass, and silver borosilicate glass.

110. The decorative panel as in claim 108, wherein the wear layer comprises antimicrobial additives both above and below its paper layer,
wherein the concentration of antimicrobial additives in the wear layer is substantially the same above and below the paper layer of the wear layer.

111. The decorative panel, as in claim 108 wherein the decor layer comprises antimicrobial additives.

112. The decorative panel in accordance with claim 111, wherein the antimicrobial additives in the decor layer are selected from one or more of particles comprising silver components, particles comprising silver phosphate, silver phosphate glass particles, quaternary ammonium salts, quaternary ammonium groups built into the matrix of the melamine resin of the decor layer, particles or additives that comprise quaternary ammonium groups, metallic silver particles, silver salts, silver complexes, silver chelates, copper salts, copper and alloys thereof, zinc oxide, essential oils, oleoresins, polybiguanides, chitosan, isothiazolinone, antibiotics, or trichloromethylsulfenyl-containing fungicides, silver adsorbed to silicon oxide, silver chloride adsorbed to titanium dioxide, silver nitrate, silver sodium hydrogen zirconium phosphate, silver zinc zeolite, silver copper zeolite, silver phosphate glass, and silver borosilicate glass.

113. The decorative panel in accordance with claim 108, wherein the wear layer comprises particles that increase the wear resistance, selected from one or more of nanosilicate, aluminum oxide, corundum, diamond and synthetic diamond.

114. The decorative panel as in claim 108, wherein the wear layer comprises, both between its paper layer and the side facing the decor layer and between its paper layer and the side facing away from the paper layer, particles that increase the wear resistance.

115. The decorative panel as in claim 108, wherein the substrate is selected from a wood fiberboard, an MDF (medium density fiberboard) panel, an HDF (high density fiberboard) panel, a chipboard, a thermoplastic panel, a polyvinyl chloride-based panel, a mineral panel, a magnesium oxide board, a fiber cement board, a fiber plaster board, a silicate board, and a mineral fiber board.

116. The decorative panel as in claim 108, wherein the surface of the panel comprises a texture embossed into the decorative surface of the panel,
wherein the deepest depressions of this texture also comprise the decor layer and the wear layer,
wherein the decor layer and/or the wear layer also comprise(s) antimicrobial additives in these deepest depressions of the texture.

117. A decorative panel, wherein the decorative panel is a parquet panel, a multiple-layer parquet panel, a composite parquet panel, or a so-called “engineered wood” panel;
wherein the decorative panel comprises a wood-based decor layer to which at least one lacquer layer is applied,
wherein the wood-based decor layer is a wood veneer layer or a wood layer thicker than a veneer layer;
wherein the at least one lacquer layer comprises at least one lacquer layer that comprises antimicrobial additives.

118. The decorative panel as in claim 117, wherein the antimicrobial additives in the lacquer layer are selected from one or more of particles comprising silver components, particles comprising silver phosphate, silver phosphate glass particles, quaternary ammonium salts, quaternary ammonium groups built into the lacquer layer, particles or additives that comprise quaternary ammonium groups, metallic silver particles, silver salts, silver complexes, silver chelates, copper salts, copper and alloys thereof, zinc oxide, essential oils, oleoresins, polybiguanides, chitosan, isothiazolinone, antibiotics, or trichloromethylsulfenyl-containing fungicides, silver adsorbed to silicon oxide, silver chloride adsorbed to titanium dioxide, silver nitrate, silver sodium hydrogen zirconium phosphate, silver zinc zeolite, silver copper zeolite, silver phosphate glass, and silver borosilicate glass.
